(19) United States
(12) Patent Application Publication
(10) Pub. No.: US 2026/0051151 A1
(43) Pub. Date: Feb. 19, 2026

(54) METHOD AND DEVICE FOR TRAINING AN OCCUPANCY NETWORK

(71) Applicant: Robert Bosch GmbH, Stuttgart (DE)

(72) Inventors: Simon Boeder, Hannover (DE); Fabian Gigengack, Hemmingen (DE)

(21) Appl. No.: 19/296,130

(22) Filed: Aug. 11, 2025

(30) Foreign Application Priority Data
Aug. 16, 2024 (DE) 10 2024 207 840.9

(51) Int. Cl. G06V 10/764; G06T 7/50; G06T 15/08; G06V 10/44

(52) U.S. Cl. CPC G06V 10/764; G06T 7/50; G06T 15/08; G06V 10/44; G06T 2207/20081; G06V 2201/07

(57) ABSTRACT

A method and a device for training an occupancy network for classification and/or object recognition of an object in a scene.

### FIELD

The present invention relates to a method and device for training an occupancy network for classification and/or object recognition of an object in a scene.

### BACKGROUND INFORMATION

Most current 2D and 3D object recognition methods (OD) can usually recognize known object classes such as cars, pedestrians or traffic lights. These algorithms use machine learning and have learned many examples of these objects from annotated data during model training. The latest approaches for camera-based object recognition methods are BEVDet and BEVFormer. These methods transfer 2D image features from multiple cameras into a common bird's eye view (BEV) space where object recognition is performed. Furthermore, YOLOv9 describes an updated iteration of the conventional 2D object recognition model. PETR and StreamPETR describe object-centric approaches for 3D recognition.

For AD to be considered safe, it is crucial to recognize every object that could collide with the vehicle in all directions and to ensure 360° coverage.

Other work takes a more self-supervised approach that does not require additional sensors such as LiDAR and radar. Instead, it uses standard models such as SAM and DINO for pre-calculating the pseudo-ground truth or exploiting photometric losses through rendering. Although these methods can estimate the general geometry of the scene, they are bound to a predefined set of classes on which they were trained.

Since the introduction of occupancy networks for autonomous driving, the concept of voxel-based 3D representations has also been increasingly adopted by academic research. Although capable of representing generic scene geometries, most of these methods rely on enormous amounts of expensive, annotated 3D data and are still bound to a series of predefined classes.

In recent years, the popularity of large image processing-based encoders such as DINO, EVA-02 or CLIP has also increased significantly. These methods have been trained on a huge dataset and have learned to extract very generic visual features in a high-dimensional feature space.

### SUMMARY

According to a first aspect of the present invention, a method for training an occupancy network for classification and/or object recognition of an object in a scene is provided. According to an example embodiment of the present invention, the method comprises the steps of:
providing 2D image data of the scene;
extracting ground truth features from the 2D image data by means of a pre-trained feature encoder in order to provide respective ground truth feature embeddings;
extracting image features for each 2D image of the provided 2D image data by means of a feature extraction network of the occupancy network;
transforming the extracted 2D image features into a 3D voxel space by means of an occupancy transformer of the occupancy network in order to estimate a 3D occupancy probability and respective queryable 3D features of a particular voxel of a predetermined voxel grid in the voxel space;
back-transforming the estimated 3D occupancy probability and the estimated queryable 3D features into a 2D representation by means of volume rendering;
training the occupancy network based on a loss function over the 2D representation of the estimated 3D occupancy probability and the estimated queryable 3D features and based on the ground truth feature embeddings; and
providing the trained occupancy network for classification and/or object recognition of an object in a scene.

It is understood that the steps according to the present invention, as well as other optional steps, do not necessarily have to be carried out in the order shown, but can also be carried out in a different order. Other intermediate steps can also be provided. The individual steps can also comprise one or more sub-steps without departing from the scope of the method according to the present invention.

According to a second aspect of the present invention, a device for training an occupancy network for classification and/or object recognition of an object in a scene is provided. According to an example embodiment of the present invention, the device comprises an evaluation and computing unit which is designed to execute the following steps:
providing 2D image data of the scene;
extracting ground truth features from the 2D image data by means of a pre-trained feature encoder in order to provide respective ground truth feature embeddings;
extracting image features for each 2D image of the provided 2D image data by means of a feature extraction network of the occupancy network;
transforming the extracted 2D image features into a 3D voxel space by means of an occupancy transformer of the occupancy network in order to estimate a 3D occupancy probability and respective queryable 3D features of a particular voxel of a predetermined voxel grid in the voxel space;
back-transforming the estimated 3D occupancy probability and the estimated queryable 3D features into a 2D representation by means of volume rendering;
training the occupancy network based on a loss function over the 2D representation of the estimated 3D occupancy probability and the estimated queryable 3D features and based on the ground truth feature embeddings; and
providing the trained occupancy network for classification and/or object recognition of an object in a scene.

The explanations given for the method of the present invention apply accordingly to the device. It is understood that linguistic modifications of features formulated for the method can be reformulated for the device in accordance with standard linguistic practice, without such formulations having to be explicitly listed here.

The present invention particularly relates to the field of general object recognition. The present invention addresses the challenge of generic object recognition and generic scene understanding, in particular from multiple optical sensor images in automated driving and/or robot applications. The present invention achieves this primarily by matching the volumetric representation present in a scene with a feature extractor which can provide generically queryable features. The volumetric representation of the scene is obtained from the application of self-supervised deep learning techniques and differentiable volume rendering. Instead of predictions in image space or bird's-eye view (BEV) space, the presented invention models the environment to be recognized, for example of a vehicle, by using a three-dimensional voxel grid in which each voxel is assigned an occupancy which indicates whether or not the region of this voxel is occupied by an object. This decouples the semantics from the geometry, which makes a generic object definition possible.

The deep learning model according to the present invention thus preferably uses images from optical sensors, for example a multi-camera unit, for predicting the occupancy of a scene by objects. Occupancy can be ascertained by means of generally queryable features within a 3D voxel grid. The generically queryable features can be provided by an established generic feature encoder, such as CLIP, DINO and others. The generic queryable features can be language-oriented for example, so that natural language queries (e.g., “show me all of the cars in this scene”) can be used for retrieval (open vocabulary assignment). Instead of only recognizing specific object classes, the proposed occupancy representation makes interactive querying possible in order to recognize any scene content encoded by the generic encoder. The present invention thus facilitates the training of a generic object recognition model in a self-supervised manner, by which the need for expensive and time-consuming 3D labeling is eliminated.

This representation models any 3D geometry in the scene to be recognized, wherein each potential object, regardless of its class, can be recognized solely based on its occupancy. The concept of the occupancy network (ON) makes an implicit and continuous 3D reconstruction of individual objects in a scene possible.

The present invention is trained in a self-supervising way and therefore does not require annotated 3D data. This is made possible by using differentiable volumetric rendering. This technique optimizes a neural network in order to encode the volumetric density and color of a scene and create new photorealistic views of the scene. The differentiable rendering process uses a learned implicit scene representation for rendering the views. The present invention uses the differentiable rendering mechanism in order to transfer predicted information from a 3D space back into a 2D space in which a self-supervised training loss can be defined. The present method makes a generic representation of a scene to be recognized possible by means of generic features that can also be described by natural language, for example.

The method of the present invention distills the knowledge of the above-mentioned models into an occupancy network in order to make a generic 3D representation possible. This generic 3D representation can be queried depending on the selection of a feature encoder. For example, if CLIP is selected as the learning model, an occupancy estimate of the occupancy network can be matched by means of natural language, which makes an open vocabulary for occupancy possible within the occupancy network.

The present invention combines the data efficiency of self-supervising NeRFs with the 3D scene representation dictated by the occupancy grid and generic queryable features (e.g. the image-speech matching provided by CLIP). The present invention makes possible true generic object recognition that can be queried (e.g., via natural language) instead of class-specific recognition from labeled training data. It makes self-supervising possible for efficient training and data efficiency via the volume rendering mechanism. The volumetric 3D representation is more accurate than the 2D BEV and therefore makes more accurate predictions possible. The model can be fed new data at any time without the need to label or calculate the ground truth (lifelong learning). It has a generalizable and scalable model design, which is particularly applicable to a different number of optical sensors and/or for different sensor types and/or at different sensor poses and/or for any resolution. It preferably has an option for a refinable, fine-grained model head in order to predict a higher resolution of the occupancy of an image scene when required. It is further explainable since the geometric 3D representation can be interpreted and evaluated by a human.

The present invention makes possible the training of a generic queryable occupancy network, which can in particular represent any geometries and/or semantics by using a series of input images, detected by a multi-camera module for example, in a self-supervising manner.

The occupancy probabilities estimated by the occupancy transformer and the estimated and queryable 3D features of a particular voxel of the predetermined voxel grid in the voxel space are initially represented in a high-dimensional latent space, so that they cannot be directly interpreted by humans. In order to match the generic queryable 3D features with a pre-trained generic feature encoder (e.g., the vision language encoder CLIP), the same input images are also fed into the generic feature encoder, in order to thus calculate generic features in the image space. The estimated generic 3D features that can be queried are transferred back into the 2D image space with the aid of differentiable volume rendering.

The training method of the present invention has self-supervising only via image data and also has the ability for online or real-time adaptation. Furthermore, the occupancy network can be continuously retrained and thus optimized. Furthermore, the method and trainable model are extremely scalable.

In order to train the occupancy network, the occupancy probabilities are used in particular as densities. Furthermore, differentiable volume rendering is used to transfer the estimated generic queryable 3D features to the incoming image data. Starting from the occupancy network output signals, rays are preferably cast from the sensor views to the image data through the voxel grid (virtually) for each pixel. Then, points along each ray are sampled, wherein the predicted generic queryable features and the density are integrated in order to calculate an individual generic queryable feature per pixel. This can be thought of as rendering the 3D predictions from the network into 2D images in order to validate the predictions.

The loss function (e.g., cosine similarity) between the rendered features and the pre-calculated generic queryable features is preferably used for training the learnable parameters of the occupancy network. The volume rendering mechanism is only used during training in order to provide the supervising signal. The renderer is no longer used in inference. Furthermore, occupancy probabilities do not require additional, separate supervising to be correctly predicted. The rendering process inherently requires correct geometry predictions from the model and provides a gradient so that the occupancy probabilities and the language feature estimates are trained jointly by a single loss.

In order to learn geometry predictions via volume rendering, many intersecting rays are preferably needed, which means that a plurality of different optical sensors having overlapping viewpoints are desired. For training purposes, the frames of adjacent time steps can also be loaded into the video sequence of an individual optical sensor and additionally rendered into this optical sensor in order to obtain more overlapping sensor positions or viewing angles. The same optical sensor preferably has a high viewpoint overlap in different time steps.

In a further aspect of the present invention, it is provided that the loss function is optimized by backpropagating a loss.

A loss can then be calculated by the loss function preferably between the 2D features from the pre-trained 2D encoder or feature encoder and the rendered estimated features. This makes training the occupancy network possible, particularly including the occupancy probabilities. In essence, this training mechanism makes it possible for the model to predict the same generic queryable features as the previously trained 2D encoder (e.g. CLIP), wherein the features are now defined in the 3D voxel space instead of the 2D image space. Furthermore, the rendering process facilitates the concurrent training of occupancy probabilities, since accurate geometry estimates are necessary to learn high-quality generic queryable features.

In a further aspect of the present invention, it is provided that the feature extraction network comprises a backbone network or feature pyramid network.

The input images, detected by one or more cameras in a time step for example, are preferably fed into a standard backbone architecture such as ResNet in order to thus extract 2D image features. Any other backbone network or feature pyramid network can also be used. Subsequently, a 2D-to-3D transformation network, for example, is used to transform the 2D image features from the backbone into features on the 3D voxel grid.

In a further aspect of the present invention, it is provided that each of the 3D features (231) is defined by a multidimensional vector per voxel, wherein each of these vectors describes a semantic content of a particular voxel in a latent space.

In a further aspect of the present invention, it is provided that the loss function (430) is further adapted by means of depth supervising information to form depth information data that are additionally provided.

In order to extend the capabilities of the trained occupancy network, two additional variants are provided. On the one hand, explicit depth supervising from additional sensor data. On the other hand, task-specific refinement through training in a lower-dimensional subspace. The proposed architecture makes it easy to add more sensor data when available in order to stabilize and strengthen the training. Another approach for improving the supervising of scene geometry estimation is the use of point clouds, generated, for example, from LiDAR data. Voxels with LiDAR points are most likely occupied, while any voxel between the vehicle and the LiDAR point is most likely unoccupied. Taking advantage of this assumption, an additional loss can be formulated for the loss function in order to train the occupancy predictions of the occupancy network. As a result, the convergence speed and the robustness of the training are increased.

If the generic feature encoder used is a vision language model such as CLIP, it is possible to switch the training process to a task-specific, low-dimensional representation of the original task. This adjustment can lead to an increase in training speed and a reduction in storage costs. Furthermore, by focusing training on the known low-dimensional part of the embedding space, the recognition performance of objects related to the specific task can be improved. Training having the original features of the visual language provided by standard encoders such as CLIP offers high representation performance but also requires computational effort during training. In addition, these encoders are usually capable of describing much more semantic content than is required in an individual scenario (e.g. autonomous driving or robot navigation). Alternatively, the visual-linguistic feature space can be restricted to a smaller subspace that contains semantic information for a specific domain of interest.

Instead of using the original feature representation provided by the vision language encoder, an auto-encoder is trained on the features prior to the actual occupancy network training. This auto-encoder can be a neural network or a simple linear transformation which is optimized for a predefined set of text queries. Given a set of embeddings for text queries, the auto-encoder initially encodes these embeddings into a lower dimensional representation. Subsequently, it decodes the features back into the original embedding space (with the goal of reconstructing the input), as is common with auto-encoders. After training, the encoder part of this auto-encoder can be used to encode all features, both visual and textual, into the vocabulary-specific low-dimensional space. Since the auto-encoder is only trained on the embeddings of the text queries, training usually only takes a few seconds.

In a further aspect of the present invention, it is provided that the occupancy transformer (220) carries out forward propagation or backward propagation.

The present invention is independent of the exact implementation of the occupancy transformer. Various machine learning approaches are possible, such as forward projection methods or backward projection methods. After the image features have been transformed into the voxel grid, they are preferably fed simultaneously or sequentially into two additional neural networks (so-called heads) of the occupancy network. The first head preferably predicts, for each voxel, an occupancy probability which estimates how likely it is that this voxel is occupied or not.

The second network preferably predicts a generic, queryable feature vector for each voxel. These two networks preferably each consist of a plurality of blocks of 3D convolutional layers and linear layers. The output of these heads is the final output of the occupancy network and can be interpreted in particular as a geometric representation (occupancy probability) and a semantic representation (e.g., visual language features) of the scene.

In a further aspect of the present invention, an inference method for classification and/or object recognition of an object in a scene by means of a trained occupancy network is proposed. The occupancy network is trained according to the present method.

During inference, only the occupancy predictions and queryable predictions are preferably used for downstream tasks, e.g., natural language queries or object recognition. A noise mechanism is preferably used exclusively for supervising the occupancy network during training. After the occupancy network has been trained by means of the mechanism explained here, it can be used for predicting scene content in 3D space based on the generic queryable features and aligned queries. The query process is explained below using natural language as an example. However, the proposed method is not limited to this specific case.

Example: Given a text query, e.g. “walker” or “traffic sign,” the feature encoder (e.g. CLIP) is used to calculate the embedding of these text queries. By using the result of the occupancy network, the text embeddings can then be compared with the voxel-based features. In the case of a generic feature encoder, which may be different from a vision language model such as CLIP, the query can be defined by any downstream task of the generic feature encoder in the original 2D space (including the network components), which task is applied to the generic queryable features in 3D voxel space.

In a further aspect of the present invention, a control unit is also provided, which is included in a vehicle having an autonomous driving function and/or a robotic system and/or an industrial machine, and on which the present training method and/or inference method of the present invention can be carried out in one of its aspects.

In a further aspect of the present invention, a computer program having program code is provided for carrying out at least parts of the present method in one of its aspects when the computer program is executed on a computer. In other words, a computer program (product) comprising instructions which, when the program is executed by a computer, cause the computer to carry out the method/the steps of the method in one of its aspects.

In a further aspect of the present invention, a computer-readable data carrier having program code of a computer program is proposed for carrying out at least parts of the present method in one of its aspects when the computer program is executed on a computer. In other words, the present invention relates to a computer-readable (memory) medium comprising instructions which, when executed by a computer, cause the computer to carry out the method/the steps of the method in one of its aspects.

The described embodiments and developments of the present invention can be combined with one another as desired.

Further possible embodiments, developments, and implementations of the present invention also include combinations not explicitly mentioned of features of the present invention described above or in the following relating to the exemplary embodiments.

### BRIEF DESCRIPTION OF THE DRAWINGS

The figures are intended to impart further understanding of the embodiments of the present invention. They illustrate example embodiments and, in connection with the description, serve to explain principles and concepts of the present invention.

Other embodiments and many of the mentioned advantages are apparent from the figures. The illustrated elements of the figures are not necessarily shown to scale relative to one another.

FIG. 1 is a schematic flow chart of an exemplary embodiment of a method according to the present invention.

FIG. 2 is a schematic block diagram of an exemplary embodiment of a method according to the present invention.

In the figures, identical reference signs denote identical or functionally identical elements, parts or components, unless stated otherwise.

### DETAILED DESCRIPTION OF EXAMPLE EMBODIMENTS

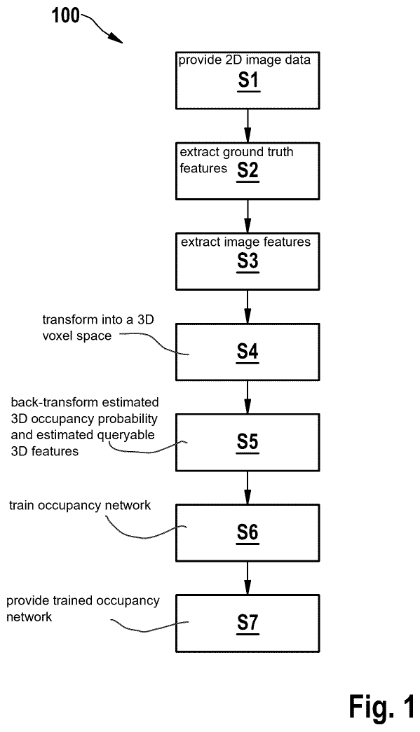

FIG. 1 is a schematic block diagram of the present method for training an occupancy network for classification and/or object recognition of an object in a scene.

In any embodiment, the method can be carried out, at least in part, by a device 100, which, for this purpose, can comprise a plurality of components not shown in more detail, for example one or more provisioning units and/or at least one evaluation and computing unit. It is self-evident that the provisioning unit can be designed together with the evaluation and computing unit or can be different therefrom. Furthermore, the device 100, which can be part of a system, can comprise a storage unit and/or an output unit and/or a display unit and/or an input unit.
In a step S1, 2D image data 110 of the scene are provided.
In a step S2, ground truth features 310 are extracted from the 2D image data 110 by means of a pre-trained feature encoder 300 in order to provide respective ground truth feature embeddings 320.
In a step S3, image features are extracted for each 2D image of the provided 2D image data by means of a feature extraction network 210 of the occupancy network 200.
In a step S4, the extracted 2D image features are transformed into a 3D voxel space by means of an occupancy transformer 220 of the occupancy network 200 for estimating a 3D occupancy probability 230 and respective queryable 3D features 231 of a particular voxel of a predetermined voxel grid in the voxel space.
In a step S5, the estimated 3D occupancy probability 230 and the estimated queryable 3D features 231 are back-transformed into a 2D representation 400 by means of volume rendering 410.
In a step S6, the occupancy network 200 is trained based on a loss function 430 over the 2D representation 400 of the estimated 3D occupancy probability 230 and the estimated queryable 3D features 231 and based on the ground truth feature embeddings 320.
In a step S7, the trained occupancy network 500 is provided for classification and/or object recognition of an object in a scene.

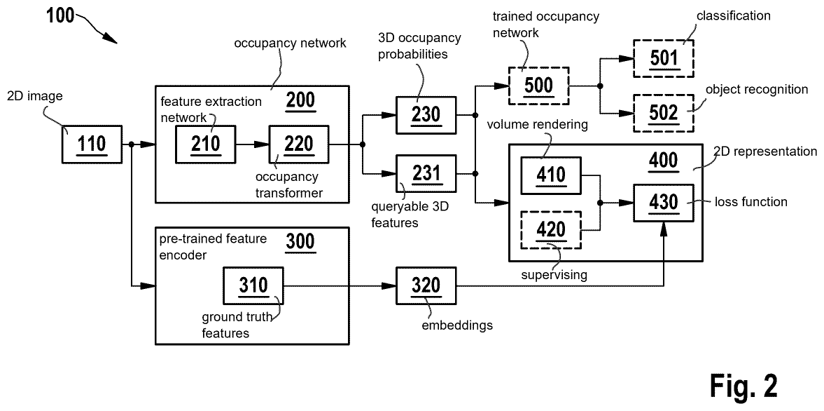

FIG. 2 shows a signal chain for the present method. The 2D image data 110, e.g., camera or sensor images of a vehicle (in particular camera images from nuScenes), are used as input for the occupancy network 200. A feature extraction network 210 is used to generate image features, preferably individually for each image of the 2D image data. Furthermore, the occupancy transformer 220 transforms the 2D image features into the 3D voxel space, and in doing so provides two outputs for each voxel in the predefined voxel grid, which can be spanned, for example, from or around the optical sensor or sensors. One of the outputs is the 3D occupancy probabilities 230, which represent the estimation and confidence of the model or of the occupancy network 200 as to whether or not the particular voxel of the voxel grid is occupied. As a further output, the, in particular generic, queryable 3D features 231 are obtained. These 3D features 231 are preferably defined by a multidimensional vector per voxel, wherein each of these vectors represents the semantic content of the particular voxel in a latent space.

For supervising purposes, generic, queryable ground truth features 310 are further extracted from the input images of the 2D image data 110. A pre-trained feature encoder 300, e.g., CLIP, is used to calculate the embeddings 320 of the ground truth features 310 for training. This is preferably done during data preprocessing. The ground truth features 310 preferably indicate respective 2D-related vision-language features by which an image element can be described by language elements, in particular by natural language. Furthermore, the estimated occupancy probabilities 230 and the generic queryable features 231 are converted or back-transformed into the 2D space by means of volume rendering 410, and a loss on the pre-calculated embeddings 320 is calculated by means of the loss function 430. This loss is preferably propagated backward through the entire model or occupancy network 200 in order to thus train the occupancy network 200. Additionally, but optionally, explicit depth supervising 420 can be used to improve geometry supervising. After training is complete, the results of the trained occupancy network 500 can be used in any downstream task. Such a task can, for example, involve object recognition 502 or object classification 501 in a scene. During inference, rendering and/or explicit depth supervising is preferably no longer performed. A query for image classification by means of the trained occupancy network 500 can then preferably be carried out by means of a freely formulatable query in natural language (e.g. “show me a trash can”; “show me a streetlight”; “show me a bridge”; “show me a pedestrian”; “show me a tire”; etc.). The trained occupancy network 500 also preferably makes 3D object recognition possible in the image scenes of the input images.

1-10. (canceled)

11. A method for training an occupancy network for classification and/or object recognition of an object in a scene, the method comprising the following steps:
providing 2D image data of the scene;
extracting ground truth features from the 2D image data using a pre-trained feature encoder to provide respective ground truth feature embeddings;
extracting image features for each 2D image of the provided 2D image data using a feature extraction network of the occupancy network;
transforming the extracted 2D image features into a 3D voxel space using an occupancy transformer of the occupancy network to estimate a 3D occupancy probability and respective queryable 3D features of a particular voxel of a predetermined voxel grid in the voxel space;
back-transforming the estimated 3D occupancy probability and the estimated queryable 3D features into a 2D representation using volume rendering;
training the occupancy network based on a loss function over the 2D representation of the estimated 3D occupancy probability and the estimated queryable 3D features and based on the ground truth feature embeddings; and
providing the trained occupancy network for classification and/or object recognition of an object in a scene.

12. The method according to claim 11, wherein the loss function is optimized by backpropagation of a loss.

13. The method according to claim 11, wherein the feature extraction network includes a backbone network or feature pyramid network.

14. The method according to claim 11, wherein each of the 3D features is defined by a multidimensional vector per voxel, wherein each of the multidimensional vectors describes a semantic content of a particular voxel in a latent space.

15. The method according to claim 11, wherein the loss function is further adapted using depth supervising information to form depth information data that are additionally provided.

16. The method according to claim 11, wherein the occupancy transformer carries out forward propagation or backward propagation.

17. An inference method for classification and/or object recognition of an object in a scene using a trained occupancy network, the occupancy network having been trained by a method including the following steps:
providing 2D image data of the scene;
extracting ground truth features from the 2D image data using a pre-trained feature encoder to provide respective ground truth feature embeddings;
extracting image features for each 2D image of the provided 2D image data using a feature extraction network of the occupancy network;
transforming the extracted 2D image features into a 3D voxel space using an occupancy transformer of the occupancy network to estimate a 3D occupancy probability and respective queryable 3D features of a particular voxel of a predetermined voxel grid in the voxel space;
back-transforming the estimated 3D occupancy probability and the estimated queryable 3D features into a 2D representation using volume rendering;
training the occupancy network based on a loss function over the 2D representation of the estimated 3D occupancy probability and the estimated queryable 3D features and based on the ground truth feature embeddings.

18. A non-transitory computer-readable data carrier on which is stored program code of a computer program for training an occupancy network for classification and/or object recognition of an object in a scene, the program code, when executed by a computer, causing the computer to perform steps comprising the following:
providing 2D image data of the scene;
extracting ground truth features from the 2D image data using a pre-trained feature encoder to provide respective ground truth feature embeddings;
extracting image features for each 2D image of the provided 2D image data using a feature extraction network of the occupancy network;
transforming the extracted 2D image features into a 3D voxel space using an occupancy transformer of the occupancy network to estimate a 3D occupancy probability and respective queryable 3D features of a particular voxel of a predetermined voxel grid in the voxel space;
back-transforming the estimated 3D occupancy probability and the estimated queryable 3D features into a 2D representation using volume rendering;
training the occupancy network based on a loss function over the 2D representation of the estimated 3D occupancy probability and the estimated queryable 3D features and based on the ground truth feature embeddings; and
providing the trained occupancy network for classification and/or object recognition of an object in a scene.

19. A device for training an occupancy network for classification and/or object recognition of an object in a scene, the device comprising:
an evaluation and computing unit configured to carry out the following steps:
providing 2D image data of the scene,
extracting ground truth features from the 2D image data using a pre-trained feature encoder to provide respective ground truth feature embeddings,
extracting image features for each 2D image of the provided 2D image data using a feature extraction network of the occupancy network,
transforming the extracted 2D image features into a 3D voxel space using an occupancy transformer of the occupancy network to estimate a 3D occupancy probability and respective queryable 3D features of a particular voxel of a predetermined voxel grid in the voxel space,
back-transforming the estimated 3D occupancy probability and the estimated queryable 3D features into a 2D representation using volume rendering,
training the occupancy network based on a loss function over the 2D representation of the estimated 3D occupancy probability and the estimated queryable 3D features and based on the ground truth feature embeddings, and
providing the trained occupancy network for classification and/or object recognition of an object in a scene.
